(19) United States
(12) Patent Application Publication
(10) Pub. No.: US 2014/0009773 A1
(43) Pub. Date: Jan. 9, 2014

(54) PRINTING AND PACKAGING WORK CONTROLLER, COMPUTER READABLE MEDIUM, PRINTING AND PACKAGING WORK MANAGEMENT SYSTEM, AND PRINTING AND PACKAGING WORK CONTROL METHOD

(71) Applicant: FUJI XEROX CO., LTD., Tokyo (JP)

(72) Inventor: Ryuichi HORIGANE, Kanagawa (JP)

(73) Assignee: FUJI XEROX CO., LTD., Tokyo (JP)

(21) Appl. No.: 13/761,796

(22) Filed: Feb. 7, 2013

(30) Foreign Application Priority Data
Jul. 4, 2012 (JP) 2012-150247

(51) Int. Cl. G06K 15/02

(52) U.S. Cl. CPC G06K 15/1823
USPC 358/1.13

(57) ABSTRACT

A printing and packaging work controller includes: an instruction receiving unit that receives and accumulates a print instruction including a delivery address of a printed material; a notification receiving unit that receives from a worker a start notification indicating that the worker is available to start new packaging work; a generating unit that, upon receipt of the notification, sorts unprocessed print instructions accumulated at the time of receipt of the notification into groups each having the same delivery address, to generate work units each including print instructions having the same address; a calculating unit that calculates, for each of the work units, a time required for printing and packaging work of the work unit; and an allocation controller that selects, based on the time required, the work unit to be allocated to the worker, and supplies the print instructions of the work unit to a printer corresponding to the worker.

### CROSS-REFERENCE TO RELATED APPLICATIONS

This application is based on and claims priority under 35 USC 119 from Japanese Patent Application No. 2012-150247 filed Jul. 4, 2012.

### BACKGROUND

(i) Technical Field

The present invention relates to a printing and packaging work controller, a computer readable medium, a printing and packaging work management system, and a printing and packaging work control method.

(ii) Related Art

In an on-demand printing service, orders each including data such as contents to be printed, print settings, and settings of post-processing (processing such as folding and binding performed on printed outputs) are received online from various customers. Print data of the received orders is printed by a digital printing system. Further, if the post-processing is specified, the post-processing is performed by a post-processor included in the system. Then, individual post-processed printed materials are sorted and packaged in accordance with the delivery addresses specified in the orders, and the packages are shipped to the respective delivery addresses.

An on-demand printing service involving small-lot printing of a relatively small number of print copies requires work such as packing into the same packaging box the printed materials of multiple orders to the same delivery address. The packaging requires high-level judgment in some cases, such as a case in which the printed materials of individual orders are different in, for example, thickness or horizontal and vertical size. In this type of service, therefore, the packaging work is performed by hand in not a few cases.

In this type of service, it is common to determine, at every deadline specified by a workplace, a current workload as a group of unprocessed orders received by the deadline, sort the group of orders in the workload into groups in accordance with the delivery address, and create a work schedule in units of the groups according to the delivery address. In accordance with the schedule, the groups are sequentially allocated to workers. Each of the workers causes a printing and post-processing system of which the worker takes charge to process the orders of the allocated group, packages the processed (e.g., bound) printed materials into a necessary number of packaging boxes, and ships the boxes. Herein, the deadline is a mere boundary set for internal purposes to create the work schedule, and orders from the outside (customers) are received at any time. An order arriving after the deadline will be placed into a work unit for the next deadline.

### SUMMARY

According to an aspect of the invention, there is provided a printing and packaging work controller including a print instruction receiving unit, a start notification receiving unit, a work unit generating unit, a required time calculating unit, and an allocation controller. The print instruction receiving unit receives a print instruction including specification of a delivery address of a printed material, and accumulates the print instruction in an accumulating unit. The start notification receiving unit receives from a worker a start notification indicating that the worker has become available to start a new packaging work. Upon receipt of the start notification from the worker, the work unit generating unit sorts unprocessed print instructions accumulated in the accumulating unit at the time of receipt of the start notification into groups each having the same specified delivery address, to thereby generate work units each including print instructions having the same delivery address. The required time calculating unit calculates, for each of the generated work units, a time required for a printing and packaging work of the work unit. The allocation controller performs a control of selecting, on the basis of the calculated time required for the work unit, the work unit to be allocated to the worker, and supplying the print instructions included in the selected work unit to a printer corresponding to the worker.

### BRIEF DESCRIPTION OF THE DRAWINGS

An exemplary embodiment of the present invention will be described in detail based on the following figures, wherein:

FIG. 1 is a diagram illustrating an example of a configuration of a system of an exemplary embodiment;

FIG. 2 is a diagram illustrating an example of order information accumulated in a spooler;

FIG. 3 is a diagram illustrating an example of contents of data in a working time table;

FIG. 4 is a diagram illustrating an example of a functional configuration of a scheduler;

FIG. 5 is a diagram illustrating an example of unit working times required for respective types of print processing;

FIG. 6 is a diagram illustrating an example of unit working times required for respective types of post-processing;

FIG. 7 is a diagram illustrating an example of contents of data in a worker information database (DB);

FIG. 8 is a diagram for describing the flow of work in the system of the exemplary embodiment;

FIG. 9 is a diagram illustrating an example of a result of “name-based search” in the order situation of FIG. 2;

FIG. 10 is a diagram illustrating a calculation example of estimated work completion times of work units as the result of “name-based search” in FIG. 9;

FIG. 11 is a diagram illustrating an example of a procedure of a control for adding a newly arrived order to an ongoing work unit; and

FIG. 12 is a diagram illustrating an example of a processing procedure in a case in which the system includes printers different in processing speed performance.

### DETAILED DESCRIPTION

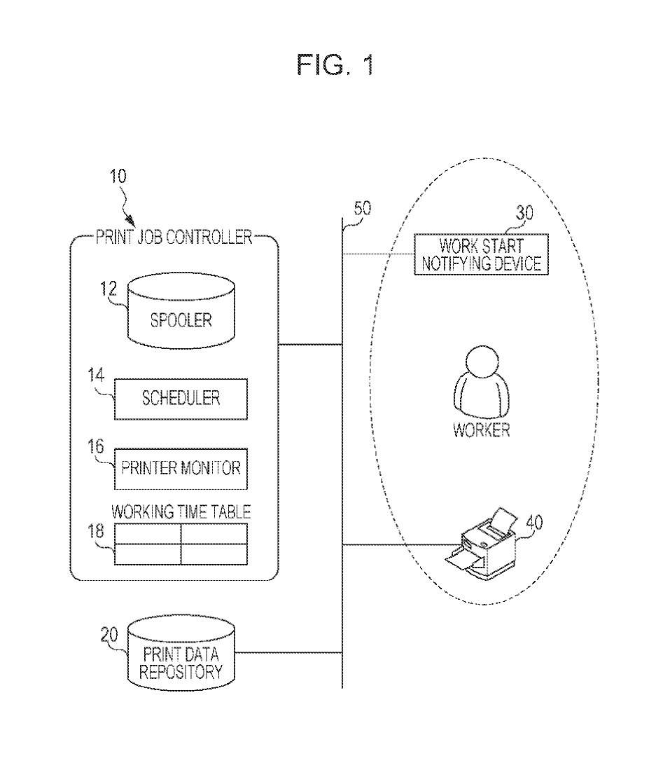

With reference to FIG. 1, description will be made of a configuration example of a printing and packaging work management system of the present exemplary embodiment. The system illustrated in FIG. 1 includes a print job controller 10, a print data repository 20, a work start notifying device 30, and a printer 40, which are configured to be able to communicate with one another via a common network (e.g., local area network) 50.

The printer 40 is a device which prints on sheets print data allocated by the print job controller 10. Further, in this example, the printer 40 includes (but not necessarily) a post-processor which performs post-processing, such as binding, stapling, punching, folding, envelope enclosing, and envelope sealing. Although the drawing illustrates only one printer 40, multiple printers 40 may be installed in a workplace employing the system. Each worker is in charge of one or more printers 40, and performs a packaging and shipping work of printed materials output from the printers 40 (e.g., printed materials subjected to post-processing such as binding). For example, the worker packs the printed materials into a box, places an address label on the box, and carries the box to a carry-out area.

The work start notifying device 30 is a device which is placed near (or may be installed in) the printer 40 and receives a notification operation performed by the worker to notify that the worker has become available to start the work for the next work unit.

Herein, the work unit refers to a group of one or more orders with the same delivery address. The orders with the same delivery address indicate that products, i.e., printed materials produced in accordance with the orders may be packaged and shipped together. In the case of small-lot, on-demand printing, multiple small-lot orders with the same delivery address (e.g., multiple orders from different sections of the same company) arrive in many cases.

The work start notifying device 30 includes, for example, a hardware button or a graphical user interface (GUI) button. When the worker becomes available to start the next work unit, the worker presses the button as the notification operation. In response to the notification operation performed by the worker, the work start notifying device 30 transmits a work start notification signal to the print job controller 10. Accordingly, the print job controller 10 performs a process for allocating the next work unit to the worker corresponding to the work start notifying device 30 (i.e., the worker in charge of the printer 40 corresponding to the work start notifying device 30).

In an example, one work start notifying device 30 is provided for each worker. If each worker is in charge of multiple printers 40, one work start notifying device 30 is provided for the multiple printers 40. With each worker thus associated with one work start notifying device 30, the print job controller 10 is capable of identifying the worker having issued the work start notification by identifying the work start notifying device 30 from which the notification has arrived. This is, of course, a mere example, and the work start notifying device 30 may be provided for each printer 40. In this case, if each worker is in charge of multiple printers 40, the print job controller 10 may hold information of correspondence between the work start notifying devices 30 (i.e., the printers 40) and the workers. Further, the work start notifying device 30 may be shared by multiple workers, and each worker issuing the notification may input his/her identification information to the work start notifying device 30 (e.g., hold a wireless tag identification (ID) card over the work start notifying device 30 as the notification operation) such that the identification information of the worker having issued the notification is transmitted from the work start notifying device 30 to the print job controller 10.

The print job controller 10 is a device which receives an order (i.e., print instruction) from a customer via, for example, the Internet, and controls the execution of a printing and packaging work for the received order. The print job controller 10 includes a spooler 12, a scheduler 14, a printer monitor 16, and a working time table 18.

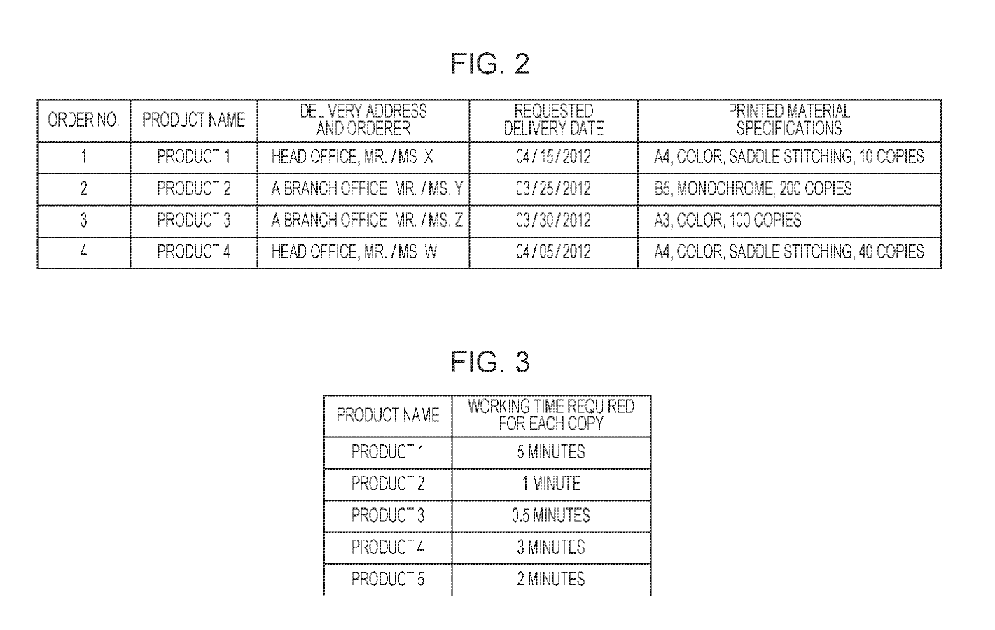

The spooler 12 acquires the data of the print order from the customer, registers in the print data repository 20 print data (described in a page description language, for example) specifying document content to be printed included in the data of the order, generates an order information item on the basis of the data of the order, and accumulates (spools) the order information item. The order information item is information for managing one order, and includes, for example, the data of items exemplified in FIG. 2.

In the example of FIG. 2, each order information item includes information of items of order No. (order number), product name, delivery address and orderer, requested delivery date, and printed material specifications. The order No. corresponds to an identification number for uniquely identifying the order. The product name corresponds to an identification name of a product (i.e., printed material) to be produced in accordance with the order. For example, if ten copies of printed materials are produced, each of the copies of printed materials is a “product.” The product name may be given by the orderer and transmitted as included in the data of the order, or may be automatically and uniquely assigned by the print job controller 10. For example, the print data is registered in the print data repository 20 in association with the product name. The delivery address and orderer corresponds to a pair of identification information of the delivery address of the products produced in accordance with the order (in the illustrated example, the facility corresponding to the delivery address) and identification information of the orderer (in the illustrated example, the individual or section having placed the order). The requested delivery date represents the requested delivery date specified by the orderer. The printed material specifications corresponds to information of settings (i.e., information of specifications) of the printing and post-processing for the print data. Print settings include items such as the number of print copies, the sheet size, the sheet quality, the selection between monochrome printing and color printing, and the option for duplex printing. Post-processing settings include the specification of the type of post-processing (e.g., various types of binding such as saddle stitching and various types of folding such as Z-folding) to be applied to each of the copies of print results.

The order information item in the spooler 12 may be managed with the status of the order (e.g., “unprocessed (waiting for allocation to worker),” “being processed,” or “processed”) registered therewith. Alternatively, the order information item may be deleted from the spooler 12 upon allocation of the corresponding order to a worker, and the status of the allocated order may be managed by another device.

Returning to the description of FIG. 1, in accordance with the work start notification arriving from the work start notifying device 30, the scheduler 14 allocates to the worker having issued the notification an unprocessed order present in the spooler 12 at the time of arrival of the notification. The scheduler 14 of the present exemplary embodiment does not schedule, at one time, a group of orders accumulated by a fixed periodical deadline, and employs a strategy of determining, in accordance with the real-time order situation at the time of arrival of the work start notification, a group of orders (a work unit) to be allocated to the worker having issued the notification. Further, in the present exemplary embodiment, a work unit falling within the working time of the worker is preferentially selected in this allocation, to thereby reduce as much as possible a situation in which the allocated work is not completed within the working time of the worker. Further, in the present exemplary embodiment, if an order with the same delivery address as that of the allocated work unit arrives after such allocation, the new order is added, where possible, to the allocated work unit to thereby improve working efficiency.

Further, as a preparatory process for such allocation, the scheduler 14 also performs a process of calculating a working time required for the printer 40 to produce, through the printing and post-processing, a product (i.e., “one copy” of printed material) of the order received and registered in the spooler 12 (referred to as the “unit working time”). The calculated unit working time for each product is registered in the working time table 18.

FIG. 3 illustrates an example of contents of data in the working time table 18. As illustrated in FIG. 3, in the working time table 18, the total time of the printing and post-processing work of the printer 40 required for each copy of product corresponding to the product name is registered in association with the product name. A method of calculating the unit working time for each product will be later described with reference to a specific example.

Returning to FIG. 1, the printer monitor 16 monitors the operating state of the printer 40. For example, the printer monitor 16 monitors to detect whether the printer 40 is in an executing state or in an idle (resting) state. However, this is an example, and the monitoring may be performed with subdivided states. The monitoring may be realized by, for example, a system in which, at each change in state, such as the start or end of printing or post-processing, the printer 40 notifies the printer monitor 16 of the change in state, and the printer monitor 16 updates, in accordance with the notification, the state information of the printer 40 managed therein.

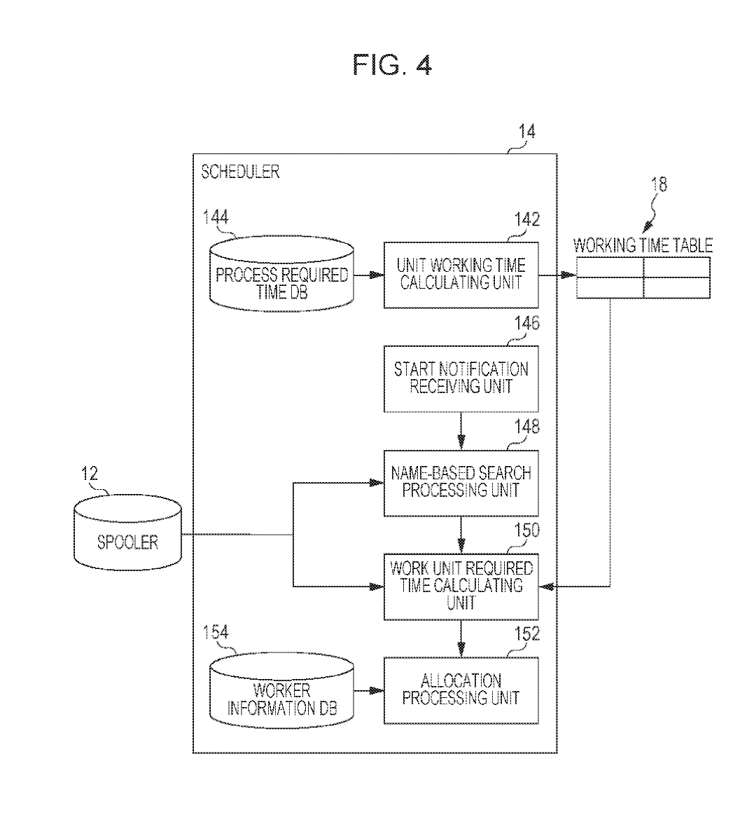

The scheduler 14 will now be described in more detail with reference to FIG. 4.

In this example, the scheduler 14 includes a unit working time calculating unit 142, a process required time database (DB) 144, a start notification receiving unit 146, a name-based search processing unit 148, a work unit required time calculating unit 150, an allocation processing unit 152, and a worker information DB 154.

The unit working time calculating unit 142 calculates a unit working time required for producing (printing and post-processing) each copy of product. The calculation is performed with the information of the printed material specifications included in each order information item and the information registered in the process required time DB 144.

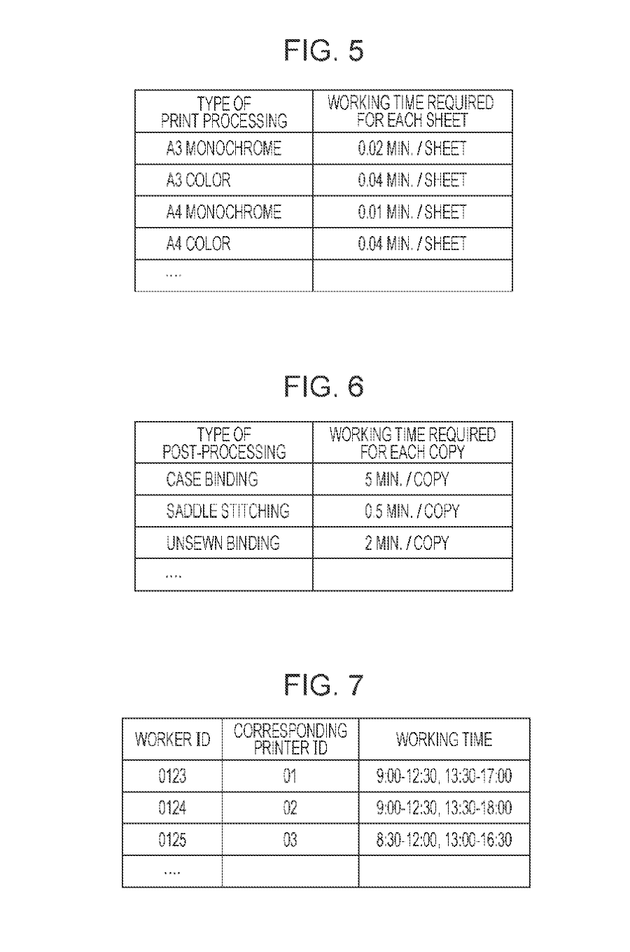

For each of types of the print processing and the post-processing, the time required for the printer 40 to perform the type of processing is registered in the process required time DB 144. An example of the data registered in the process required time DB 144 is illustrated in FIGS. 5 and 6. FIG. 5 illustrates an example of the time required for each sheet in each of the types of the print processing (in the example of FIG. 5, the combination of sheet size and color or monochrome printing). If it is also possible to specify the option for duplex printing, the type of the print processing is also classified in accordance with whether or not duplex printing is selected, in addition to the sheet size and the color or monochrome printing. FIG. 6 illustrates an example of the time required for each copy of printer material in each of the types of the post-processing (various binding styles such as case binding and saddle stitching, for example). Although illustration is omitted, the information of the time required for the packaging process (e.g., box-packing work) and the time required for the shipping process (e.g., work of placing a label with delivery address on a box and carrying the labeled box to the carry-out area) is also registered in the process required time DB 144. The time required for the packaging and shipping process may be specified for each box (each package), for example. If multiple boxes are required to pack the printed materials of the work unit allocated to the worker, the time required for the packaging and shipping process of each box is multiplied by the number of boxes, to thereby calculate the time required for each work unit. Each of the packaging process and the shipping process is performed by hand by workers, and thus there is some variation in the actual time required. In the process required time DB 144, a general time required may be registered.

Upon each receipt of an order, for example, the unit working time calculating unit 142 obtains, from the process required time DB 144, the time required for printing each sheet and the time required for post-processing each copy corresponding to the printing and post-processing settings in the printing and post-processing conditions included in the order (printed material specifications of each order information item in FIG. 2). Then, the unit working time calculating unit 142 multiplies the time required for printing each sheet by the number of sheets included in each copy of product, and adds the time required for post-processing each copy to the multiplication result, to thereby obtain the unit working time for each copy of product. Herein, the number of sheets included in each copy of product may be determined on the basis of the number of pages of the print data and the printing and post-processing settings. The thus calculated unit working time of the product of each order is registered in the working time table 18 (see FIG. 3) in association with the product name.

Herein, the calculation of the unit working time of the product is performed by the scheduler 14. However, this is a mere example, and the calculation may be performed by another module included in the print job controller 10.

Units from the start notification receiving unit 146 to the worker information DB 154 of FIG. 4 are a group of modules in charge of a process for allocating work units to workers.

Upon receipt of the work start notification issued by the work start notifying device 30, the start notification receiving unit 146 instructs the name-based search processing unit 148 to perform the name-based search processing. The “name-based search” corresponds to processing of dividing multiple orders into groups in accordance with the delivery address. Each of the groups obtained as a result of the name-based search includes one or more orders with the same delivery address. In the present exemplary embodiment, this group is determined as a unit to be allocated to a worker, i.e., a “work unit.” In the name-based search processing, in addition to the grouping of orders according to the delivery address, the orders in each of the groups may be sorted in accordance with a predetermined ordering rule based on, for example, the order of the names of the orderers or the order of the addresses of the orderers (e.g., floors of a building corresponding to the delivery address). Information required for the sorting (e.g., addresses of orderers) may be compiled into a separate database.

When the start notification receiving unit 146 receives the work start notification, the name-based search processing unit 148 performs the name-based search processing on the group of order information items present in the spooler 12 at the time of receipt of the notification. If the spooler 12 is configured to retain the order information item of the order already allocated to one of the workers, a flag indicating whether or not the allocation has been done is set for each of the order information items, and the name-based search processing unit 148 performs the name-based search on the group of order information items flagged as “unallocated.” With this name-based search processing, a group of unallocated orders present in the spooler 12 at the time of receipt of the work start notification is divided into multiple work units.

For each of the work units generated by the name-based search, the work unit required time calculating unit 150 sums up the working times required for the respective processes of the printing and post-processing (performed by the printer 40) and the packaging and shipping work (performed by the worker), to thereby calculate the time required for the entire work unit. Herein, for each of the orders in the work unit, the unit working time for producing the product of the order is read from the working time table 18, and is multiplied by the number of copies specified in the printed material specifications of the order information item, to thereby calculate the time required for the printing and post-processing. The time required for each box is read from the process required time DB 144, and is multiplied by the number of boxes required for packing the products of the work unit (which is calculated by a publicly known method on the basis of, for example, the volume of the printed materials and the size of the boxes), to thereby calculate the time required for the packaging and shipping work.

On the basis of the respective times required for the work units calculated by the work unit required time calculating unit 150, the allocation processing unit 152 selects, from the work units obtained by the name-based search processing unit 148, a work unit to be allocated to the worker having issued the work start notification. In an example, this selection is performed in consideration of the working time of the worker having issued the notification, which is registered in the worker information DB 154.

As exemplified in FIG. 7, for each of the workers, the identification information of the printer 40 taken charge of by the worker (“corresponding printer ID”) and the information of the working time are registered in the worker information DB 154 in association with the identification information of the worker (“worker ID”). In the illustrated example, the start and end times of a morning working time and an afternoon working time separated by a lunch break are registered for each of the workers. If the work of each work unit is allowed to be performed before and after the lunch break, there is no need to separate the working time into the morning working time and the afternoon working time. Further, if the worker is in charge of multiple printers 40, respective IDs of the multiple printers 40 are registered as the “corresponding printer ID.” Further, if the information of correspondence between the work start notifying devices 30 in the workplace and the workers allocated therewith is previously registered in the worker information DB 154, the start notification receiving unit 146 is capable of determining the worker having issued the notification simply by identifying the work start notifying device 30 from which the notification has arrived. The worker information DB 154 may be generated from, for example, separately managed work shift information of the workers. Further, if there is an overtime work schedule, the value of the working time may be adjusted in accordance with the schedule. If all of the workers have the same working time, there is no need to separately manage the working times of the workers.

The description will now return to the allocation processing unit 152. For example, the allocation processing unit 152 preferentially selects, from the work units obtained by the name-based search, a work unit having an end time which falls within the working time of the worker having issued the notification, assuming that the work unit is now allocated to the worker. Specifically, for example, the allocation processing unit 152 adds the current time to each of the times required for the work units calculated by the work unit required time calculating unit 150, to thereby calculate respective estimated work completion times of the work units. Then, the allocation processing unit 152 selects, from work units having an estimated work completion time earlier than the end time of the working time, a work unit to be allocated to the worker having issued the notification.

If there are multiple work units having an estimated work completion time earlier than the end time of the working time, the allocation processing unit 152 may randomly select, from the multiple work units, a work unit to be allocated to the worker. Alternatively, the allocation processing unit 152 may allocate, among the multiple work units, a work unit having the latest estimated work completion time (in other words, a work unit having the longest time required). This is a strategy of preferentially allocating a work unit having the longest time required in view of that the allocation of work units becomes more difficult with the passage of time owing to the constraint of the working time.

Further, if the estimated work completion times of the work units resulting from the name-based search are all later than the end time of the working time of the worker having issued the notification, a postponable order with a long delivery date may be deleted from each of the work units to search for a work unit having an estimated work completion time which falls within the working time of the worker. Whether or not to postpone an order may be determined in accordance with a predetermined condition, such as a condition that the delivery date of the order is later than the current date and time by a predetermined period of time or longer.

The allocation processing unit 152 allocates the thus selected work unit to the worker having issued the notification, and transmits to the printer 40 taken charge of by the worker (which is retrieved from the worker information DB 154) the print data and the setting information of, for example, the printing and post-processing (printed material specifications) of the orders in the work unit, to thereby cause the printer 40 to perform the printing and post-processing. If there are multiple printers 40 taken charge of by the worker, the allocation processing unit 152 selects therefrom a printer 40 detected as being in the idle state on the basis of monitoring by the printer monitor 16 as the location to which the work unit is to be allocated, and transmits the print data and so forth to the printer 40.

Further, the allocation processing unit 152 may display, on a display screen attached to the printer 40 allocated with the work unit or to the corresponding work start notifying device 30, information of the allocated work unit (e.g., a list of orders included in the work unit and the delivery address) to allow the worker to view the information. The worker performs work such as packing into one or more boxes the products produced by the printing and post-processing of the printer 40, placing the address labels to the boxes, and carrying the boxes to the carry-out area.

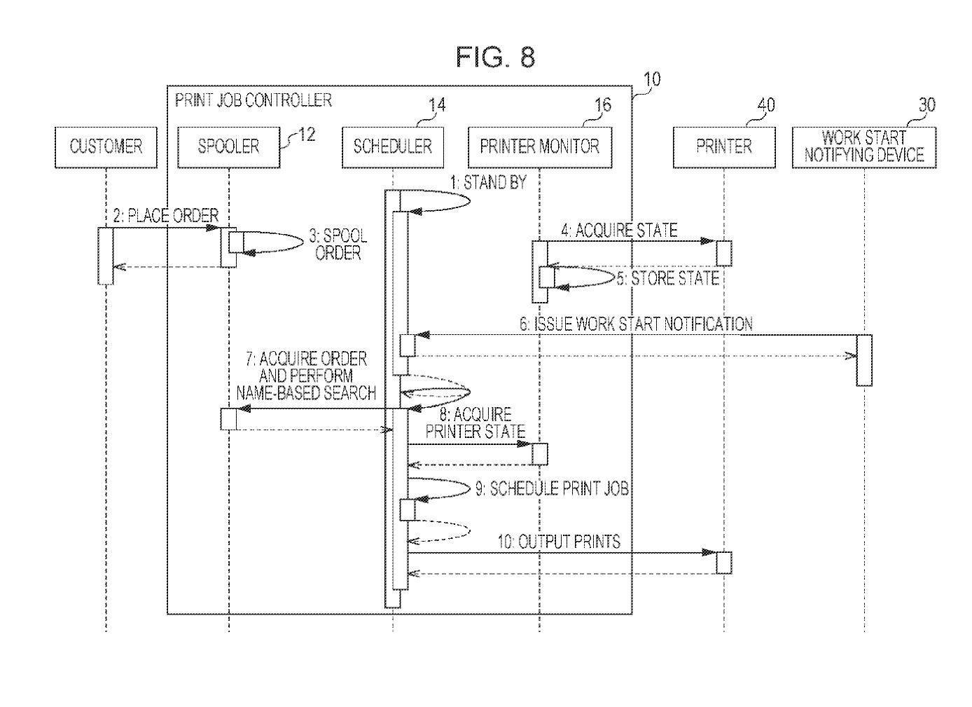

The flow of work in this system will now be described with reference to FIG. 8. In the following description, parenthesized numbers represent the numbers of steps in FIG. 8.

For example, when the print job controller 10 is activated, (1) the scheduler 14 is placed into a standby state. A customer (2) accesses the print job controller 10 via, for example, the Internet, and places an order. In the ordering, the customer registers in the print job controller 10 the print data representing the document to be printed, the printed material specifications, and the information of the orderer and the delivery address. In the print job controller 10 having received the order, (3) the spooler 12 generates and spools an order information item from the information of the order, and registers the print data in the print data repository 20. Meanwhile, the printer monitor 16 (4) acquires the state information of the printer 40 at appropriate intervals, and (5) stores the acquired latest state.

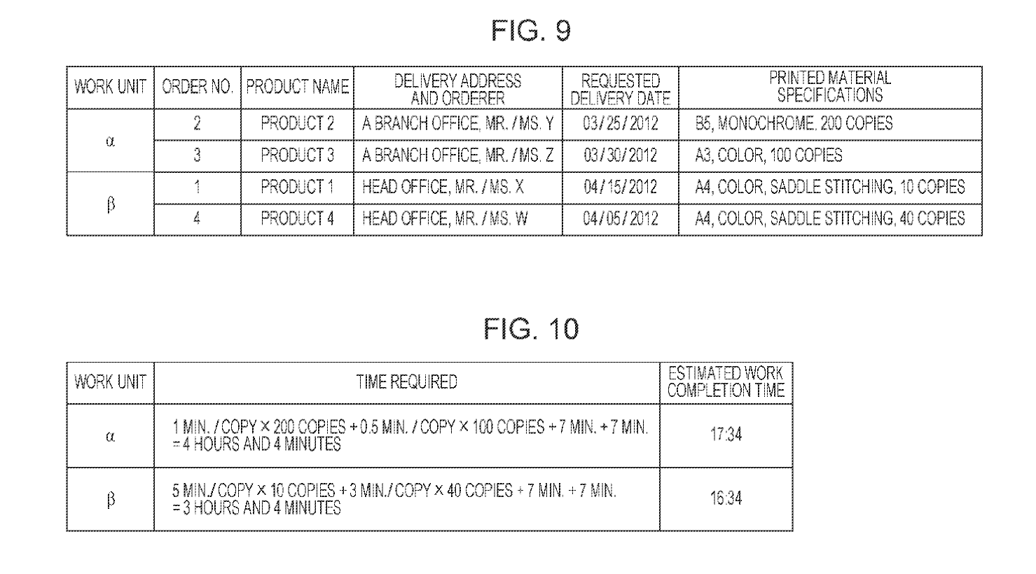

When a worker becomes available to start the next work, (6) the worker operates the work start notifying device 30 to issue a work start notification. Then, (7) scheduler 14 receives the work start notification, and performs the name-based search processing on a group of unallocated order information items present in the spooler 12 at the time of receipt of the work start notification. For example, if the group of unallocated order information items present in the spooler 12 at the time of receipt of the work start notification is as illustrated in FIG. 2, work units α and β as illustrated in FIG. 9 are generated as a result of the name-based search. The work unit α is a group of order information items with a delivery address of “A branch office,” and the unit β is a group of order information items with a delivery address of “head office.”

Further, (8) the scheduler 14 acquires from the printer monitor 16 the state of the printer 40 taken charge of by the worker having issued the notification, and checks whether or not the printer 40 is in the idle state (a state in which the printer 40 is available to start the next printing). If there are multiple printers 40 taken charge of by the worker, the scheduler 14 selects therefrom a printer 40 in the idle state.

Further, (9) the scheduler 14 calculates the respective times required for the work units generated by the name-based search, and adds the current time to each of the times required, to thereby calculate respective estimated work completion times of the work units. For example, if the current time is 13:30, the times required and the estimated work completion times of the work units α and β in FIG. 9 are as illustrated in FIG. 10. For example, the work unit a includes an order of order No. 2 for producing 200 copies of product 2 that takes one minute per copy and an order of order No. 3 for producing 100 copies of product 3 that takes 0.5 minute per copy. It is assumed herein that the products of the two orders combined fit in one box. In this case, a time of “1 minute×200+0.5 minute×100” required for the printing and post-processing of the two orders is added with a time required for packaging (seven minutes in the illustrated example) and a time required for shipping (seven minutes in the illustrated example). As a result, the time required for the work unit α is four hours and four minutes. This time required is added to the current time of 13:30, and thereby the estimated work completion time of the work unit α is determined as 17:34. It is understood that the estimated work completion time of the work unit β is determined as 16:34 from similar calculation. The scheduler 14 selects, between the work units α and β, a work unit which will be completed within the working time of the worker having issued the notification. If the worker having issued the notification corresponds to a worker ID of “0123” illustrated in FIG. 7, the work of the worker ends at 17:00. Between the work units α and β, therefore, the scheduler 14 selects the work unit β, the estimated work completion time of which is earlier than 17:00. Then, (10) the scheduler 14 allocates the selected work unit to the worker, and transmits data, such as the print data of the orders included in the work unit, to the printer 40 in the idle state taken charge of by the worker, to thereby cause the printer 40 to process the data.

Accordingly, the printer 40 sequentially performs the printing and post-processing on the orders of the work unit. The worker packages the products obtained by the processing, and performs work for shipping. Then, after the completion of the shipping work, the worker operates the work start notifying device 30 to again issue a work start notification to the scheduler 14. In response to the notification, the scheduler 14 performs, in real time and in a similar manner as described above, the name-based search processing on the group of unallocated order information items present in the spooler 12 at the time of receipt of the notification, and allocates, among the work units resulting from the name-based search, a work unit according to the working time of the worker.

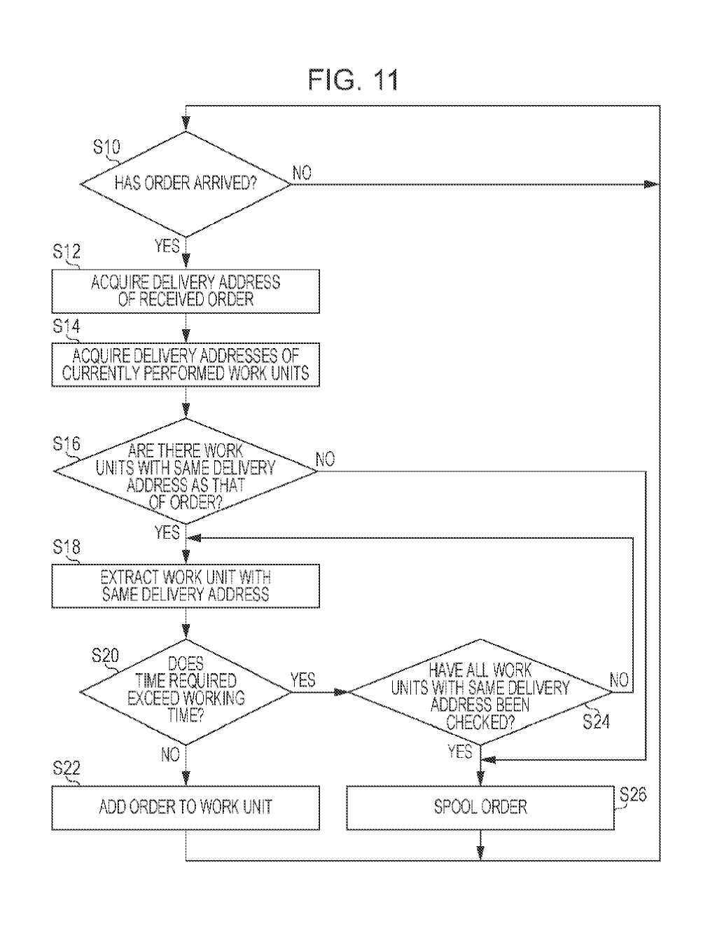

With reference to FIG. 11, description will now be made of an example of a process of adding to the ongoing work unit an order which arrives at any time. In this example, the scheduler 14 constantly monitors whether or not an order from a customer has arrived (step S10). If an order arrives, the scheduler 14 acquires the information of the delivery address of the order (step S12), and further acquires the information of the delivery addresses of the work units which are currently being performed by the workers (step S14). For example, the period from the allocation of a work unit to a worker to the arrival of the next work start notification from the worker corresponds to the period in which the work unit is “being performed.” However, this is a mere example. Alternatively, therefore, the time of completion of the printing and post-processing of the work unit by the printer 40 (which is determinable from the notification of the state of the printer 40 from the printer 40) or the time later than the time of completion by the time required for packaging (which is retrievable from the process required time DB 144) may be determined as the end of the period in which the work unit is “being performed.” For the sake of the process of step S14, the scheduler 14 retains the information of correspondence between each of the workers (and each of the printers 40) and the work unit allocated to the worker, until, for example, the arrival of the next work start notification from the worker.

Then, the scheduler 14 determines whether or not the currently performed work units acquired at step S14 include work units with the same delivery address as that of the received order (step S16). If such work units are found, the scheduler 14 extracts one of the work units (step S18), and determines whether or not the time required for the extracted work unit added with the order exceeds the working time of the worker allocated with the work unit (step S20). In this determination, the time required for printing and post-processing each copy of product of the received order (the foregoing unit working time) is calculated, and is multiplied by the number of copies of the order, to thereby calculate the time required for producing all of the products of the order by the printing and post-processing. Then, this time required is added to the estimated work completion time of the work unit extracted at step S18, to thereby obtain the estimated work completion time of the work unit added with the order. If the addition of the order results in an increase in the number of boxes required for packaging, the time required for packaging with the increased number of boxes is further added to the estimated work completion time. Then, if the thus calculated estimated work completion time is later than the end of the working time of the worker allocated with the work unit, it is determined that the time required for the work unit exceeds the working time owing to the addition of the order.

If it is determined at step S20 that the time required for the work unit added with the order does not exceed the working time of the worker (if the determination result is No), the scheduler 14 adds the order to the work unit (step S22). That is, the scheduler 14 transmits data such as the print data of the order to the printer 40 allocated with the work unit. In this case, the order is not required to be spooled in the spooler 12.

If it is determined at step S20 that the time required for the work unit added with the order exceeds the working time of the worker, the scheduler 14 determines whether or not the ongoing work units with the same delivery address as that of the received order include unchecked work units (step S24). If there are unchecked work units, one of the unchecked work units is extracted (step S18), and processes similar to those described above are repeated. If there is no unchecked work unit, the order is not allowed to be added to any of the currently performed work units. Therefore, the scheduler 14 spools the order in the spooler 12 (step S26). If it is determined at step S16 that there is no ongoing work unit with the same delivery address as that of the order, the scheduler 14 also spools the order in the spooler 12 (step S26).

The newly arrived order is thus added to a currently performed work unit, if the time required for the work unit added with the order does not exceed the working time of the worker. Accordingly, it is possible to process the order in a shorter time than in a case in which the order is processed as another work unit after the completion of the currently performed work unit. For example, it is now assumed that the worker corresponding to the worker ID of “0123” (see FIG. 7) is allocated with the work unit β (see FIGS. 9 and 10), and that an order (order No. 5) with the same delivery address of “head office” as that of the work unit β arrives when the work unit β is still being performed. If the time required for the printing and post-processing of the order is twenty minutes, for example, the time required for the work unit β added with the order corresponds to the sum of three hours and four minutes (see FIG. 10) and twenty minutes, i.e., three hours and twenty-four minutes (even if the extra twenty minutes is added to the estimated work completion time 16:34 of the work unit β, the work ends before 17:00 at which the working time of the worker ends). Meanwhile, if the order of order No. 5 is placed in another work unit different from the work unit β, the another work unit requires the sum of twenty minutes, seven minutes (for packing), and seven minutes (for shipping), i.e., thirty-four minutes, and the time required for the work unit β added with thirty-four minutes is three hours and thirty-eight minutes. Accordingly, if the order is processed together with the ongoing work unit, the total working time is reduced by fourteen minutes. Further, if the new order is placed in another work unit different from the ongoing work unit (even when the order is allowed to be added to the ongoing work unit), another box is required to package the products of the order. Meanwhile, if the new order is added to the ongoing work unit, an extra box is unnecessary, if the products of the new order fit in the vacant space of the currently used box.

Still another modified example will now be described. In this modified example, a case is assumed in which the printers 40 included in the system are different in printing or post-processing speed. In such a situation, the unit required times of the respective types of the print processing and the post-processing illustrated in FIGS. 5 and 6 are different among the printers 40. Accordingly, with reference to the unit required times of the respective types of processing of the printers 40, the unit working time calculating unit 142 (see FIG. 4) calculates, for each of the printers 40, the unit working time for each copy of product, and registers the unit working time in the working time table 18.

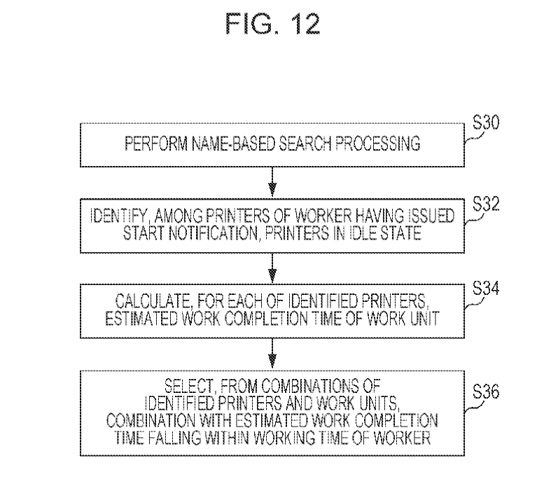

Upon arrival of the work start notification, the scheduler 14 performs the processing exemplified in FIG. 12. That is, the scheduler 14 first performs the foregoing name-based search processing (step S30). Further, with reference to the printer monitor 16, the scheduler 14 identifies, among the printers 40 taken charge of by the worker having issued the notification, printers 40 in the idle state (step S32). Then, for each of combinations of the identified printers 40 and the work units resulting from the name-based search, the scheduler 14 calculates the estimated work completion time of the work unit processed by the printer 40 (step S34). For example, in this calculation, the unit working time taken for the printer 40 to process the product of each of the orders in the work unit is retrieved from the working time table 18, and the unit working time of the product is multiplied by the number of copies (the time required for printing and post-processing each order). Then, the multiplication results of all of the orders in the work unit are summed up (the time required for printing and post-processing the work unit). The sum is added with the time required for packaging and shipping, to thereby obtain the total working time for the work unit. The total working time is added with the current time, to thereby obtain the estimated work completion time of the work unit processed by the printer 40. The scheduler 14 selects for allocation a combination in which the thus calculated estimated work completion time is earlier than the end time of the working time of the worker having issued the notification (step S36). That is, the scheduler 14 allocates the work unit included in the selected combination to the printer 40 included in the combination.

The print job controller 10 exemplified above is realized by causing, for example, a general-purpose computer to execute a program representing the processing of the above-described functional modules. Herein, for example, the computer has, as hardware, a circuit configuration in which a microprocessor such as a central processing unit (CPU), memories (primary memories) such as a random access memory (RAM) and a read only memory (ROM), a hard disk drive (HDD) controller controlling a HDD, various input/output (I/O) interfaces, a network interface controlling connection of the computer to a network such as a local area network, and so forth are connected via, for example, a bus. Further, the bus may be connected via an I/O interface or the like to, for example, a disk drive for reading from and writing to a portable disk recording medium, such as a compact disc (CD) or a digital versatile disc (DVD), or a memory reader-writer for reading from and writing to a portable nonvolatile recording medium of various standards, such as a flash memory. The program describing the processing contents of the above-exemplified functional modules is stored, via a recording medium such as a CD or a DVD or via a communication system such as a network, in a fixed memory such as a hard disk drive, and is installed in the computer. The program stored in the fixed memory is read by the RAM and executed by the microprocessor such as a CPU, to thereby realize a group of the above-exemplified functional modules. Further, a group of the above-exemplified constituent components of the print job controller 10 may be distributed and implemented in multiple computers capable of communicating with one another via a network, such that the distributed constituent components communicate with one another via the network to thereby realize the above-described functions of the print job controller 10.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A printing and packaging work controller comprising:
a print instruction receiving unit that receives a print instruction including specification of a delivery address of a printed material, and accumulates the print instruction in an accumulating unit;
a start notification receiving unit that receives from a worker a start notification indicating that the worker has become available to start a new packaging work;
a work unit generating unit that, upon receipt of the start notification from the worker, sorts unprocessed print instructions accumulated in the accumulating unit at the time of receipt of the start notification into groups each having the same specified delivery address, to thereby generate work units each including print instructions having the same delivery address;
a required time calculating unit that calculates, for each of the generated work units, a time required for a printing and packaging work of the work unit; and
an allocation controller that performs a control of selecting, on the basis of the calculated time required for the work unit, the work unit to be allocated to the worker, and supplying the print instructions included in the selected work unit to a printer corresponding to the worker.

2. The printing and packaging work controller according to claim 1, further comprising:
a working time memory that stores a working time of the worker,
wherein the allocation controller calculates, on the basis of the time required for the work unit, an estimated completion time of the printing and packaging work of the work unit performed by the worker, and allocates to the worker the work unit having the calculated estimated completion time falling within the working time of the worker.

3. The printing and packaging work controller according to claim 2, wherein, when the print instruction receiving unit receives a new print instruction, the allocation controller adds the new print instruction to the work unit being performed by the worker, if the work unit has the same delivery address as the delivery address of the new print instruction, and if the estimated completion time of the work unit added with the new print instruction falls within the working time of the worker allocated with the work unit.

4. The printing and packaging work controller according to claim 1, further comprising:
a speed performance information memory that stores information concerning print speed performance of printers;
a corresponding printer memory that stores information identifying printers taken charge of by the worker; and
a monitoring unit that monitors whether or not the printers are available to process a next print instruction,
wherein, with reference to the information stored in the speed performance information memory, the required time calculating unit calculates, for each of combinations of the generated work units and printers that are taken charge of by the worker having issued the notification and are available to process the next print instruction, the time required for the printer of the combination to process the work unit of the combination, and
wherein the allocation controller calculates the estimated completion time for each of the combinations on the basis of the time required for the combination, identifies the combination having the calculated estimated completion time falling within the working time of the worker, and allocates the work unit of the identified combination to the printer of the combination.

5. The printing and packaging work controller according to claim 2, further comprising:
a speed performance information memory that stores information concerning print speed performance of printers;
a corresponding printer memory that stores information identifying printers taken charge of by the worker; and
a monitoring unit that monitors whether or not the printers are available to process a next print instruction,
wherein, with reference to the information stored in the speed performance information memory, the required time calculating unit calculates, for each of combinations of the generated work units and printers that are taken charge of by the worker having issued the notification and are available to process the next print instruction, the time required for the printer of the combination to process the work unit of the combination, and
wherein the allocation controller calculates the estimated completion time for each of the combinations on the basis of the time required for the combination, identifies the combination having the calculated estimated completion time falling within the working time of the worker, and allocates the work unit of the identified combination to the printer of the combination.

6. The printing and packaging work controller according to claim 3, further comprising:
a speed performance information memory that stores information concerning print speed performance of printers;
a corresponding printer memory that stores information identifying printers taken charge of by the worker; and
a monitoring unit that monitors whether or not the printers are available to process a next print instruction,
wherein, with reference to the information stored in the speed performance information memory, the required time calculating unit calculates, for each of combinations of the generated work units and printers that are taken charge of by the worker having issued the notification and are available to process the next print instruction, the time required for the printer of the combination to process the work unit of the combination, and
wherein the allocation controller calculates the estimated completion time for each of the combinations on the basis of the time required for the combination, identifies the combination having the calculated estimated completion time falling within the working time of the worker, and allocates the work unit of the identified combination to the printer of the combination.

7. A computer readable medium storing a program causing a computer to execute a process for controlling a printing and packaging work, the process comprising:
receiving and accumulating a print instruction including specification of a delivery address of a printed material;
receiving from a worker a start notification indicating that the worker has become available to start a new packaging work;
sorting, upon receipt of the start notification from the worker, unprocessed print instructions accumulated at the time of receipt of the start notification into groups each having the same specified delivery address, to thereby generate work units each including print instructions having the same delivery address;
calculating, for each of the generated work units, a time required for a printing and packaging work of the work unit; and
performing a control of selecting, on the basis of the calculated time required for the work unit, the work unit to be allocated to the worker, and supplying the print instructions included in the selected work unit to a printer corresponding to the worker.

8. A printing and packaging work management system comprising:
a printer;
a start notification input device that is placed near the printer, and receives, from a worker in charge of packaging a printed material output from the printer, an input of a start notification indicating that the worker has become available to start a new packaging work; and
a printing and packaging work controller including
a print instruction receiving unit that receives a print instruction including specification of a delivery address of the printed material, and accumulates the print instruction in an accumulating unit,
a start notification receiving unit that receives the start notification from the start notification input device,
a work unit generating unit that, upon receipt of the start notification from the worker, sorts unprocessed print instructions accumulated in the accumulating unit at the time of receipt of the start notification into groups each having the same specified delivery address, to thereby generate work units each including print instructions having the same delivery address,
a required time calculating unit that calculates, for each of the generated work units, a time required for a printing and packaging work of the work unit, and
an allocation controller that performs a control of selecting, on the basis of the calculated time required for the work unit, the work unit to be allocated to the worker, and supplying the print instructions included in the selected work unit to a printer corresponding to the worker.

9. A printing and packaging work control method comprising:
receiving and accumulating a print instruction including specification of a delivery address of a printed material;
receiving from a worker a start notification indicating that the worker has become available to start a new packaging work;
sorting, upon receipt of the start notification from the worker, unprocessed print instructions accumulated at the time of receipt of the start notification into groups each having the same specified delivery address, to thereby generate work units each including print instructions having the same delivery address;
calculating, for each of the generated work units, a time required for a printing and packaging work of the work unit; and
performing a control of selecting, on the basis of the calculated time required for the work unit, the work unit to be allocated to the worker, and supplying the print instructions included in the selected work unit to a printer corresponding to the worker.
